(19) United States
(12) Patent Application Publication
(10) Pub. No.: US 2012/0324392 A1
(43) Pub. Date: Dec. 20, 2012

(54) PAGE-BASED ELECTRONIC BOOK READING WITH COMMUNITY INTERACTION SYSTEM AND METHOD

(75) Inventors: Ernest V. Mbenkum, Toronto (CA); Mark Hempel, Edina, MN (US)

(73) Assignee: LIGHTCODE, INC., Toronto (CA)

(21) Appl. No.: 13/163,795

(22) Filed: Jun. 20, 2011

(51) Int. Cl. G06F 3/048

(52) U.S. Cl. 715/776

(57) ABSTRACT

A system and method is presented for the web-based reading of books. Users of the system access books page-by-page through a computerized web server, with a social community oriented around each book being presented in conjunction with the book. Data is maintained in a database relating to user, author, and publisher additions to the book-oriented social community. At least a portion of these additions are associated with particular pages in the book. These page-specific additions are made available to the user only when the user has reached the particular page associated with the addition. A listing of other users currently reading the same page, or nearby pages, is presented to the user, allowing interactions with other users to be controlled according to the specific page being read by the user.

### RELATED APPLICATIONS

The present application is related to the co-pending application entitled “Network Based Electronic Book Usage Tracking System and Method,” attorney docket number 4701, filed on the same date and with common inventors as the current application.

### FIELD OF THE INVENTION

The present application relates to the field of network-based book publishing. More particularly, the described embodiments relate to a system and method in which users access books page by page through a computerized web server, with a social community oriented around each book being presented in conjunction with the reading of the book.

### BRIEF DESCRIPTION OF THE DRAWINGS

FIG. 1 is a block diagram showing a computerized system in use with a plurality of users, authors, and publishers.

FIG. 2 is a block diagram showing a server computer operating a web server to present interfaces over the World Wide Web.

FIG. 3 is a block diagram showing user related database elements.

FIG. 4 is a diagram showing a reading interface for one embodiment of the present invention.

FIG. 5 is a diagram showing a reader map.

FIG. 6 is a flow chart showing a method for importing a document.

### DETAILED DESCRIPTION

### Overview

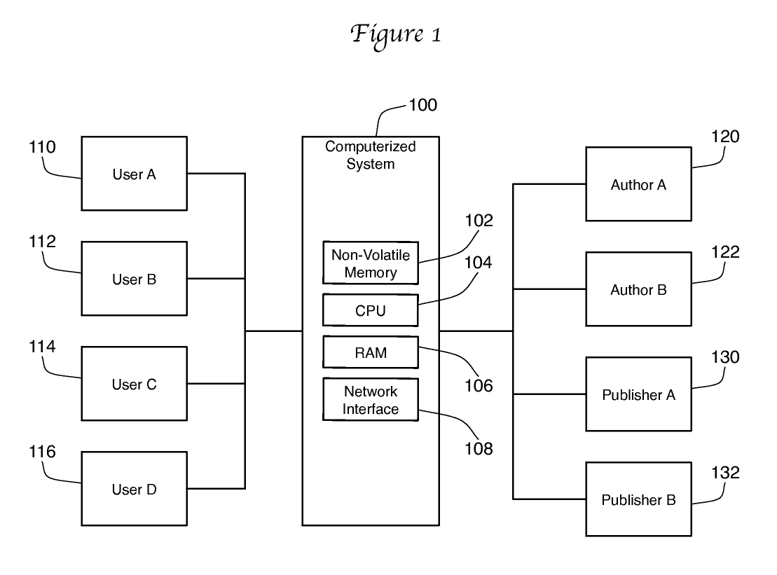

FIG. 1 is a block diagram showing a plurality of users 110-116, authors 120-122, and publishers 130-32 that are connected through a computerized system 100. The computerized system 100 provides an interactive interface to users 110-116 that allows users to page through and read one or more books. In the present description, users 110-116 are those individuals who use the computerized system 100 to read a book, to review information and content about the book, and to interact with other parties concerning that book. Authors 120-122 are those individuals who authored the books that are available for reading on the system 100. Publishers 130-132 are the entities that publish the printed version of the books, or entities that otherwise assist in the publicity for or distribution of the books.

In this description, the term author, publisher, and book are used to describe an embodiment of the present invention. However, it is not necessary that the material being read by a user constitute a book per se. For instance, the content may be a journal article, a news report, etc. The authors using the system would not then be book authors or publishers, but could be a writer, journalist, or any other type of content creator. The publisher also need not be a written book publisher, but could be any entity that works on publicity or distribution of the written content. Consequently, the word book should be construed broadly to mean written content, the word author should be construed to mean the creator of the written content, and the word publisher should be construed to mean an entity involved in publicity or distribution of the written content.

The computerized system 100 includes a set of software instructions or interfaces stored on a non-volatile, non-transitory, computer readable medium 102 such as a hard drive or flash memory device. A digital processor 104, such as a general purpose CPU manufactured by Intel Corporation (Mountain View, Calif.) or Advanced Micro Devices, Inc. (Sunnyvale, Calif.) accesses and performs the software. To improve efficiency, processor 104 may load software stored in memory 102 into faster, but volatile RAM 106. Data operated upon by the software can also be stored in non-volatile memory 102 and retrieved into RAM 106 for analysis, recording, and reporting. The computer system 100 further includes a network interface 108 to communicate with other computerized devices across a digital data network. In one embodiment, the network is the Internet or an Intranet, and the network interface 108 includes TCP/IP protocol stacks for communicating over the network. The network interface 108 may connect to the network wirelessly or through a physical wired connection. Instead of being a single computer with a single processor 104, the computerized system 100 could also implemented using a network of computers all operating according to the instructions of the software.

By using the computerized system 100, users 110-116 not only receive access to the book that they wish to read, but they also participate on a social community related to that book. Unlike many other computerized social networks, the community created by the computerized system 100 is oriented around a particular book. By organizing the community in this manner, the system is able to combine the act of reading a book with interaction with that book's social community. The social communities created by the computerized system 100 include content created by, and interaction between other users 110-116 who are also reading the book, the author or authors 120-122 of the book, and other entities such as publishers 130-132 who are publicizing and attempting to generate interest in the book.

For instance, user A 110 may be interested in reading a particular book using the computerized system 100. In this example, the author of the book, author A 120, has decided to use the computerized system 100 to distribute her book and to reach out to the community of users reading her book. Author A 120 likely made the decision to use the computerized system 100 with the advice or consent of her publisher, namely publisher A 130. Author A 120 and publisher A 130 work together to provide access to the book using the customized interfaces of system 100. User A 110 purchases the right to read the book, and is given full text access to the book through the user's own interface to the computerized system 100. User A 110 is also given access to book related supplemental materials, updates, and blog posts created by the author A 120 and publisher A 130. At the same time, other users 112-116 also purchase the right to access the book and receive access to the same materials provided by the author 120 and publisher 130.

While reading the book, user A 110 may wish to make a note about a particular page in the book. By using the computerized system 100, user A 110 may make a private note for later review of user A 110, or can add that note publicly to the social community organized around the book. Assuming that the note has been made public, user B 112 may read that note when reaching the same page in the book, and can respond either directly to user A 110 or to the community as a whole about that note. User C 114 may read the same page and then generate an unrelated note for the next reader. In this way, participants in the community surrounding the book generate additional content that becomes valuable for future users, such as user D 116. As this cognitive surplus for a book develops, users 110-116 will begin to turn to the computerized system 100 as much for the book's community and related content than for simple, full text access to the book's content.

Even after submitting a book for distribution, author A 120 may return frequently to the computerized system 100 to participate in the communities that have developed around her books. Such participation may be of personal interest and enjoyment to the author, while also helping to increase interest and readership of the author's books. In addition, author A 120 may request statistics concerning user interaction with the book. The computerized system 100 can respond by informing the author 120 of the total number of users who have purchased access to the book, the number of active readers, the number of notes left for the book, and other statistics related to the book. In addition, by tracking user interaction with the particular pages of the book, the computerized system 100 can provide author A 120 with valuable insights into the way users perceive different parts of the book. For instance, the computerized system 100 can indicate the pages that contain the greatest number of notes and the greatest amount of interaction between users 110-116. By tracking the time spent on particular pages, the computerized system 100 can also inform the author 120 which pages users read quickly, and which pages users read slowly. In fact, by tracking pages read over time, the computerized system can determine whether a user has effectively abandoned the reading of a particular book, and the page where the user stopped reading the book (the user's “defection point”). Similar statistics can be made available to publishers 130-132 about their books, allowing both authors 120-122 and publishers 130-132 to obtain valuable feedback on the particular strengths and weaknesses of various books based on actual monitoring of user reading habits.

### Implementation as a Web Server

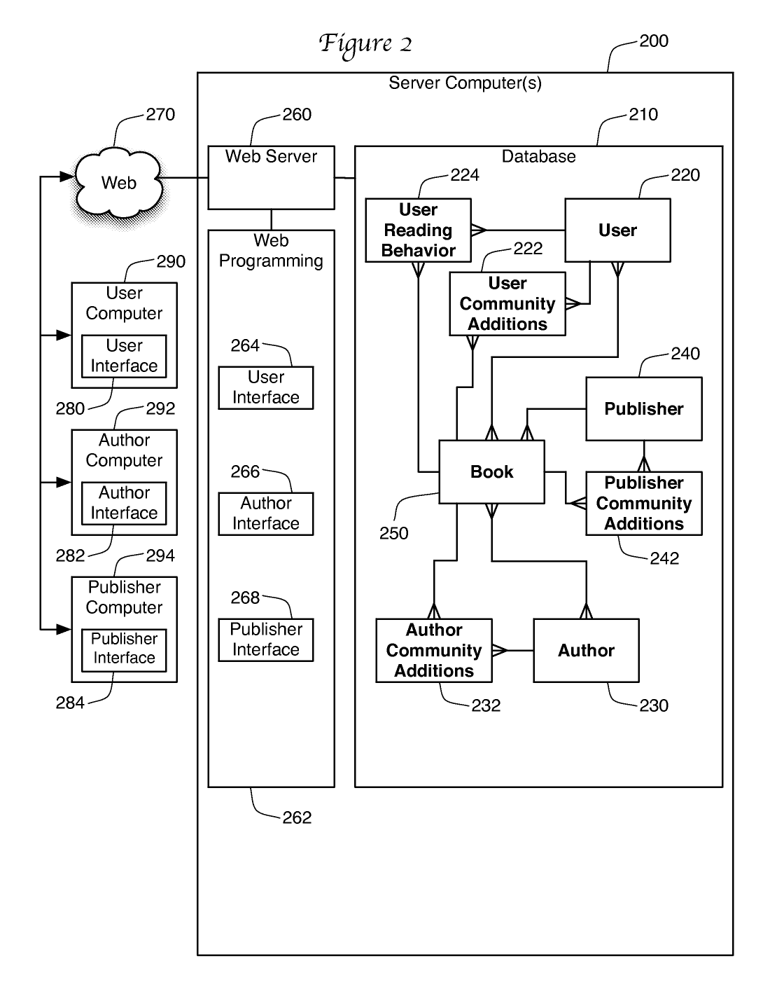

The computerized system 100 of FIG. 1 can be implemented as one or more web server computers 200 as shown in FIG. 2. The computerized system 200 is capable of storing information about all of the parties that use the system 200. In the preferred embodiment, this information is stored by the server computer 200 in a database 210. This information can be maintained as separate tables in a relational database, or as database objects in an object-oriented database environment within the database 110. FIG. 2 shows the database 210 with tables or objects for users 220, authors 230, publishers 240, and books 250. This allows the database 210 to maintain information about the users 110-116, authors 120-122, and publishers 130-132 that may access the server computer 200. Of course, the table or object entities shown in FIG. 2 should not be considered to show actual implementation details of the database 210, since it is well within the scope of the art to implement this type of data using a variety of entity architectures. The entities shown are exemplary, intended to aid in the understanding of the data maintained by the system database 210 in this embodiment. For example, it would be well within the scope of the present invention to divide information about users 220 into multiple tables or objects, instead of the single user entity 220 shown in FIG. 2. Similarly, it would be possible to implement the database 210 such that information about users, authors, and publishers all use a single database table or object, where the role (user, author, publisher) for each instance is defined using a field within that table or object. Finally, it is not even necessary to implement these entities as formal tables or objects, as other database paradigms could also effectively implement these types of data structures.

Relationships between these entities 220-250 as well as the other entities in the database 210 are represented in FIG. 2 using crow's foot notation. For example, FIG. 2 shows that a book 250 may have multiple authors 230, but only a single publisher 240. Each author 230 and publisher 240 can, in turn, have multiple books 250. Users 220 in the database 210 can be associated with multiple books 250, and each book 250 can itself be associated with multiple users 220.

The database also tracks the contributions made to the community surrounding a book 250 by each of the various participants. For instance, each user 220 can make multiple user community additions 222 to the system 200. These additions 222 may include page notes, chapter comments, book reviews and ratings, chat room contributions, etc. While each user 220 may make user community additions 222 about any book 250 with which they are associated in the database 210, each user community addition 222 is related to only one particular book 250. Similarly, each author 230 may make author community additions 232 to the database 210, thereby allowing the author 230 to make comments, updates, and blog posts about one of their books 250. In one embodiment, each author addition 232 is associated with only a single book 250, as shown in the crow's feet notation of FIG. 2. In other embodiments, authors 230 are granted the ability to make author community additions 232 that are associated with multiple books 250. For instance, the author 230 may maintain a general blog 232, which the author 230 wishes to make available to users 220 of all of the books 250 authored by that author 230. Alternatively, the author may have a blog that is associated with a particular series of books (i.e., the historical mysteries) written by the author but is not associated with other books by that same author. Similarly, publishers 240 may make publisher community additions 242 relating to their books 250. The various community additions 222, 232, 242 that are associated with a book 250 together constitute the social community oriented around that book 250.

Users of the system 200 are given access to a book's content by associating their user record 220 with the appropriate book record 250 in the database. The text of the book is stored in the book record 250 or in related database records. Users whose record 220 is associated with the book 250 are granted access to the books' related community additions 222, 232, 242.

User interaction with the book's content through the sever computer 200 are stored in user reading behavior records 224. These records can indicate when a user purchased a book, or started reading that book. Additional records can track each page turn (or “page clicks”) by the user. Only by tracking user interaction with a book at the page level can some of the most useful information about the book and the user be generated.

The database 210 is used by a web server 260 operating on one or more of the server computers 200 to generate the various interfaces used by the system 10. In particular, web programming 262 exists that defines how to create a user interface 264, an author interface 266, and a publisher interface 268 using the data in the database 210. This programming 262 allows the web server 260 to transmit over the World Wide Web 270 (or an intranet) a user interface 280 that can be seen by a browser operating on a computer 290 for the benefit of a user. Similarly, the web server 260 can manage an author interface 282 on browser operating on an author computer 292, and a publisher interface 284 operating on a publisher computer 294. Each computer 290, 292, 294 could be a standard personal computer operating a Microsoft Windows, Linux, or Apple Mac OS operating system. Alternatively, these computers 290-294 could be mobile devices, such as smart phones or tablet computers, operating Google Android, Apple iOS, or Microsoft Windows Phone operation system. In addition, the device could be a “smart” or Internet enabled television.

### User Related Data

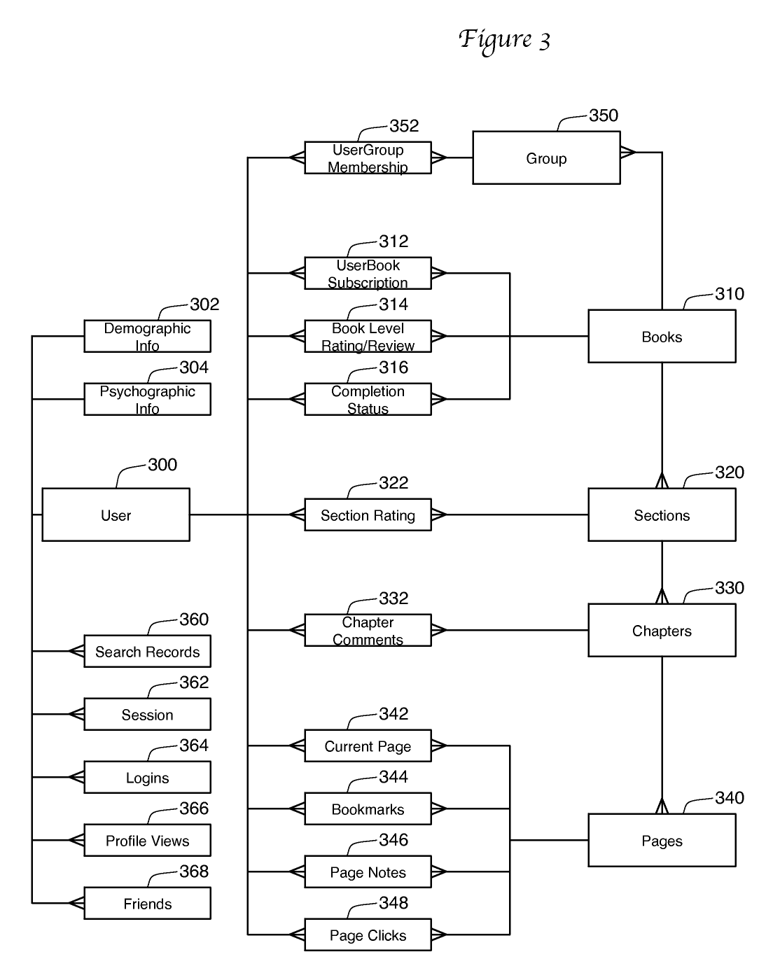

FIG. 3 shows the database elements 300-368 used by the database 210 to track information about users and their interactions with books. The user database element 300 is connected to the book element 310 primarily by the UserBook subscription 312. This element 312 indicates that the user 300 has purchased or otherwise obtained access to the book 310. For instance, the system could be designed so that users purchase subscriptions to books one at a time. Those subscriptions could be permanent, or could require that a user pay for a renewal after a given time period. Alternatively, the system could allow users to purchase unlimited access to books for a limited time period. The user would then select a book that she wishes to access, and the system would then create a UserBook subscription entry 312 assigning the book to that user. Relationships between entities in FIG. 3 can be established using any of the standard techniques known in the field of database design. In the present case, a unique user ID is assigned to each user entry 300, and a unique book ID is assigned to each book entry 310. All other entities that relate to the user 300 or book 310 make that relationship using the user ID or book ID, respectively.

User information, such as the user's name, address, username, password, etc. is stored in the user database element 300. Related records can also be created to store similar information. For instance, the database elements in FIG. 3 separate demographic info 302 (such as age, sex, geographic location, and income) and psychographic info 304 (such as reading preferences and past purchasing behavior) into separate elements from the user 300, even though it would be a simple matter to integrate this same information into the definition of a user table or object 300. The book element 310 itself contains information about the book (such as the book's title, date of copyright, ISBN number, etc.), although such data could also be located in separately defined database elements.

In the preferred embodiment, users 300 who have finished reading a book 310 are permitted to create a book rating and review 314 for the book 310. Users 300 who have not completed the book 310 may leave comments about parts of a book, but may not created a book level rating or review 314. The completion status detailing a user's interaction with a book is stored in database element 316.

In the embodiment shown in FIG. 3, books 310 are conceptually subdivided into sections 320. Sections 320, in turn, are subdivided into chapters 330, which are made up of pages 340. Each of these portions is represented by separate database elements. In the preferred embodiment, the actual content or text of the book 410 is stored in the page level database element 440. One of the primary advantages of these subdivisions is that user community additions relating to this book can be associated with the particular subdivision. For instance, users 300 are allowed to create separate section ratings 322 for each section 320, and to create chapter comments 332 for each chapter 330. Another advantage of this hierarchy system is that it allows for the smallest subdivision of a book to be defined at the page level. By keeping the book's content at this level 340, user interaction with each page can be easily monitored and analyzed. Furthermore, segmentation of the book 310 down to the page level 340 is instantly familiar and comfortable to all users 300.

On the page 340 level, the database tracks the current page 342 being reviewed by the user. By separately storing this information, the system allows a user to quickly return to their place within a book at later time, even after a significant delay between reading sessions. Locations in the book 310 of particular interest to a user can be marked using bookmarks 344. In some embodiments, simple notes or a title describing the bookmark 344 can be stored along with the page information in the bookmark entity 344. In the preferred embodiment, bookmarks 344 created by one user can be shared with other users, so that one user can see where another has bookmarked a particular book.

One of the significant advances of the present invention is its ability to allow a user to create notes 346 that are relevant to a particular page 340. Using this construct, later readers of the same book 310 can access page level notes 346 left by earlier readers, but only when the later readers reach that page. The page level notes data structure 346 can contain the actual note left by the user, as well as the user's preferences about the note. For instance, the user can designate that the note is a private note that should be viewed only by the user, or designate that the note is public, thereby allowing the system to share the note with all readers reaching that same page 340 of the book 310. In the preferred embodiment, public notes are accessible to all users 300 of the book 310, thereby allowing communication between otherwise unrelated users 300. In one embodiment, page notes 346 can relate to other notes 346, thereby allowing the creation of threaded, back-and-forth discussions within the book's community.

In another embodiment, the user can participate in a book's community as part of a group 350. A group is a subset of all users that are reading a particular book 310. In this embodiment, a third option of sharing page notes 346 can be presented, where notes can be viewed by members of the group 350 but not by other readers of the book 310. The membership of a user 300 in a group 350 is defined by the UserGroup membership database entity 352.

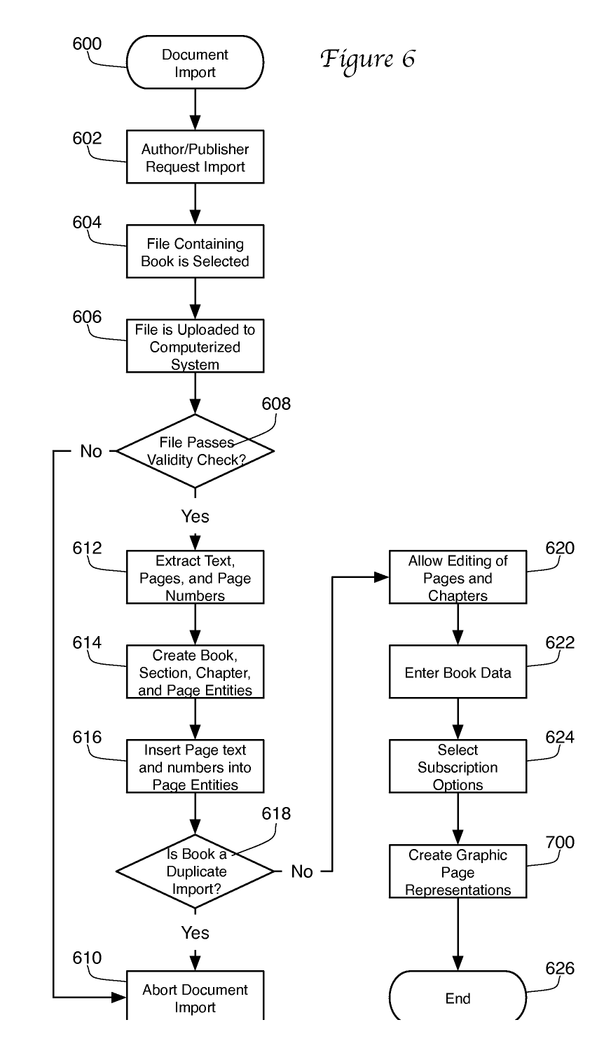

Another advance made by the present invention relates to the ability to track page clicks 348. Page click entries 348 detail when a user 300 requests access to a particular page 340 of a book 310. An analysis of page click records 348 can determine whether a user 300 has completed reading a book 310, which could then be recorded in the completion status record 316. This analysis is described below in more detail in connection with FIG. 6. Page click records 348 can also be used to determine defection points where a user 300 has stopped reading a book 310, or places where a user either skimmed a page briefly or spent significant time slowly reading through the page. Page clicks are also useful to generate reports or “heat maps” concerning the popularity of particular pages or portions (groups of pages) in a book. An author can request that a report be generated indicating the number of page clicks recorded for different pages in their book, either for all users or for a particular subgroup of users. If the report is generated in the form of a heat map, the author can see the valleys, plateaus, and mountainous regions generated by the clicks of different pages.

Page clicks 348 can even determine where a user 300 decided to look back through previous pages 340 in the book 310. Such information could be useful to an author, as it may indicate a location where the book 310 has become more confusing. Similarly, one embodiment of the present invention may record all search requests 360 made by a user 300. Search requests may relate to a particular book 310, or may be made over multiple books 310. It is even possible that search request could be made relating to books not yet subscribed to by a user 300 (as indicated by subscription link 312). By tracking the timing of a search request, it is possible to identify users 300 who are stuck at a particular page in a book who then search for references to a character or an idea earlier in the book. While some embodiments of the present invention would not share all search requests 360 made by users with authors, some sharing of this information will allow authors to see not only where (i.e., what page) cause the user confusion, but also the search request made by the user 300 to clarify the confusion.

In addition to page clicks 348 and search records 360, it may be useful to record user interaction with page notes 346 or similar community additions. For instance, each time a user requests to view the page notes 346 (or chapter comments 332 or book review 314) of another user, the database 210 could track this viewing. This would help analyze which pages inspire (or otherwise encourage) a user to look for additional content from the community. This would help the author and publisher identify pages of strong interest (or confusion) among users.

In addition, such tracking would help the system identify the users whose contribution to the community were most valued by other users. For example, in one embodiment, users are ranked based upon their total value to the community. Various scores are created for the users based on at least one of the following criteria: percentage of pages read for which the user created a note, percentage of chapters finished for which the user has created a chapter comment, percentage of books completed for which the user has submitted a book level review or responded to a book-related survey, other user's ratings of the user-created notes and comments, total logins in a given time period, and purchases made by the user within the system. The various scores can be weighted to create a total contribution score, which can then be compared to other users in order to value the overall contributions of that user.

Other types of user related data can also be maintained in the database, including a record of user sessions 362 and logins 364. Sessions 362 are used to keep track of a user's online status. If a session 362 is deleted, the user is automatically logged off the site. A user session 362 is only initiated after a successful login 364. Logins 364 track in the database 210 how often a user has logged into the site, and when they last logged in. Logins 364 also track failed logins, allowing the computerized system to create failsafe mechanisms that can suspend an account after a preset number of failed login attempts. In addition to sessions 362 and logins 364, the present invention also stores cookies in the web browser of the users, authors and publishers. Cookies can be used to store encrypted data indefinitely in those browsers, so that the users do not have to re-enter their login credentials.

The system also maintains records of user interactions with other users, such as when one user views the profile of another user (profile views 366), or when one user befriends another (record 368). As seen in other social networking environments, the linking of users 300 with friends allows users 300 to explore the interests and activities of their individually selected friends.

In addition to the user-related community contributions 314, 322, 332, and 346, the present invention also includes author- and publisher-related contributions. Much like the contributions of a user 300, these contributions can relate to an entire book 310, or to a specific section 320, chapter 330, or page 340 of a book. While no figure shows these author and publisher contributions, the relationship between these contributions and the various hierarchy levels of a book would be the same as shown in FIG. 3 with respect to users 300. More information about author and publisher contributions can also be found in the incorporated related application.

### User Reading Interface

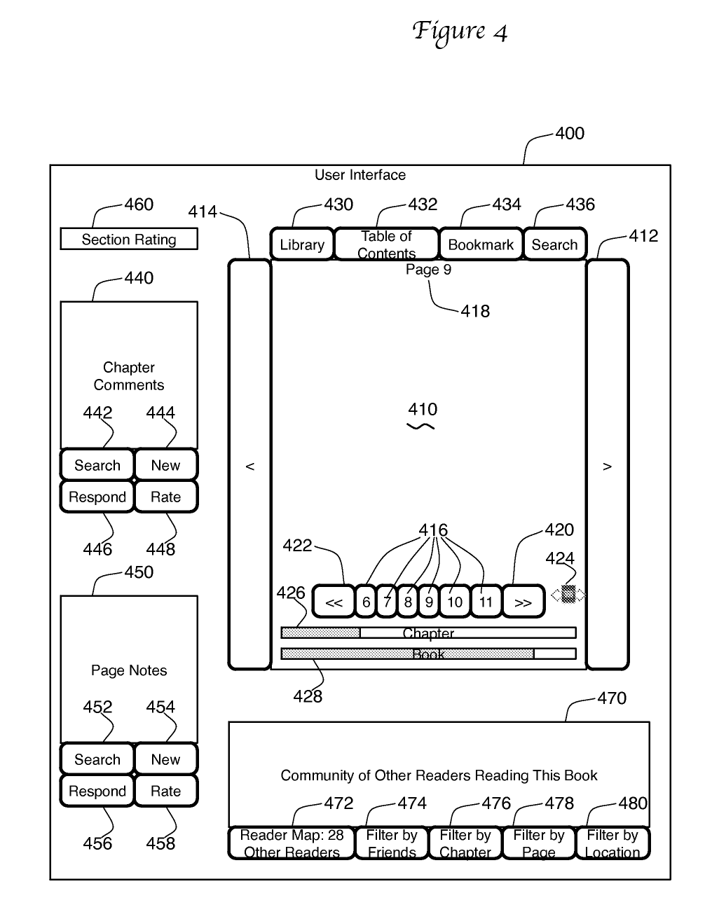

As explained above in connection with FIG. 2, a user will interact with the web-reading system of the present invention through a user interface 280 operating on a user computer 290. This user interface 280 is generated by the web server 260 operating on one or more server computers 200, and then transferred to the user computer 290 over the Internet 270, an intranet, or some other computerized network. FIG. 4 shows one embodiment of a user interface 400 that could be viewed by a user of the system of FIG. 2. This particular interface 400 is designed to allow a user to read a book that is stored in the database 210 accessed by the server computers. This database 210 may be constructed, in part, using the data entities shown in FIG. 3.

Other user interfaces may be presented to a user other than the reading interface 400 shown in FIG. 4. For example, the server computer 200 may present a user-account interface that allows users to update personal information, set security/sharing preferences, choose themes and color schemes for the interface, and establish their geographic location. A separate library interface may be presented that shows the books currently subscribed to by the user, and allows the user to browse and purchase additional books that are available on the system. Another interface may allow the user to search for other users, establish friends, and send messages to other users.

As the purpose of the reader user interface 400 is to allow the user to read a book, the current page being read 410 dominates the interface 400. In the preferred embodiment, books are read page-by-page. Consequently, the reading user interface 400 presents a single page 410 to the user. The pagination for the book is pre-established in the database 210. As shown in FIG. 3, pages 340 are pre-defined database elements, and are related to a particular book in a known and predictable way. This means that the pages and pagination presented to a first user of a book will be the same pages and pagination that are presented to all other readers of the book. This implementation is in marked contrast to other prior art online reading systems, where each user is presented different “chunks” or pages of a book than users. By presenting books in known, predetermined pages, the present invention is able to track interaction with the book on a page-by-page level using the page clicks 348 database entity that was described above. In addition, user additions to the book community can be made on a page-by-page basis, as implemented in the page notes 346 database entity.

Because the pages 410 being displayed in the interface 400 are guaranteed to be the same from user to user, it is possible to implement the pages 410 as a graphic image as opposed to pure text. The use of graphical page representations in the interface 400 as opposed to sending text as an HTML element to a web browser allows the system greater control of the visual appearance of each page. In addition, by presenting graphical image pages 410, it is more difficult for a user to grab the text of a book and use that text outside of the interface 400. This creates greater security for the books against unauthorized copying, which in turn will increase the attractiveness of the system to authors and publishers that desire strong copy protections schemes.

To move the page displayed 410 from one page to the next, the user simply presses the next page button 412, which is preferable found along the entire right side of the page window 410. Similarly, the previous page button 414 is found along the entire left side of the page window 410. It is also possible to go to a different page by pressing one of the page specific buttons 416 found at the bottom of the page 410 being read. The pages indicated by these buttons 416 initially include the page number of the current page being viewed 410. The current page is shown in FIG. 4 at location 418 to be page 9, so the page specific buttons 416 represent pages immediately before and after page 9 (in this instance, pages 6-11). To adjust the pages shown in the page specific buttons 416, a forward 420 and a reverse 422 button are presented. By pressing the forward button 420, the user causes the list of pages in the page specific buttons 416 to increase. By pressing and holding the forward button 420, the page numbers in the buttons 416 advance rapidly until the user releases the forward button 420. The reverse button 422 works similarly, but decreases the pages listed in the page specific buttons 416. In the preferred embodiment, the page specific buttons 416 and the forward 420 and reverse buttons 422 can be removed from the reading interface 400 by clicking on an icon known as a pageflip icon 424. Removing buttons 416, 420, 422 declutters the interface 400, while the constant presence of the pageflip icon 424 allows the user to recall those buttons 416, 420, 422 with a single click.

At the bottom of the page window 410 are two progress bars 426, 428. These bars 426, 428 indicate at a glance how far the user currently is in the current chapter (bar 426) and the entire book (bar 428). At the top of the page window 410 are several menu buttons 430-436. The first button 430 brings the user to the library interface, where the user can select a new book. The books in the user's library include all books to which that user has subscribed. The library interface may also include an ability to view other books available for subscription from the system. The table of contents button 432 presents the table of contents for the current book in the current page window 410. In the preferred embodiment, the table of contents shows a list of sections, chapters, and pages, along with links that allows the user to go directly to a particular portion of the book. The bookmark button creates a bookmark database entry 344 for the current user at that page. In one embodiment, the interface 400 will ask the user to give a title to the bookmark for easier identification at later times.

Finally, the search button 346 presents the user with a search interface. The search interface can be designed to allow the user to search any book in their library (i.e., any book subscribed to by the user). One or many books can be searched through this interface. Alternatively, the search interface could be limited so as to only allow searching of the book currently being read. The search results can then be presented as a list of pages in the book or books being searched that meet the search criteria. Users can jump to a reading interface 400 for that page simply by selecting the page from the search results. Regardless of the implementation details of the interface, each search request can be stored in the database as entity 360. In one embodiment, these search entities include a user identifier, the search request, the search result selected by the user, and the page 410 from which the search was initiated (if any).

One of the benefits of the present invention is for users to review chapter comments 440 and page notes 450 associated with the page 410 currently being read. The chapter comments 440 are taken from the chapter comments entity 332 in the database 210. As seen in FIG. 3, each page entity 340 is associated with a single chapter entity 330, so it is a simple matter to associate the page 410 being viewed in interface 400 with a particular chapter. The page notes 450 are taken from the page notes entity 346, which are associated with a single page entity 340. As a user moves from page to page in interface 400 (such as through buttons 412, 414), the page notes available at window 450 update automatically. As long as the pages 410 being viewed by the user are within a single chapter, the chapter comments in window 440 will remain unchanged. When the page 410 being viewed enters a new chapter, the chapter comments in window 440 will update accordingly.

In one embodiment, the chapter comment window 440 contains a listing of all available comments for the current chapter. This listing will include all public comments, comments that have been made available to the current user's groups, and the user's own private comments. The chapter comments window 440 will not include private comments written by other users. The page notes window 450 similarly lists the available page notes associated with the current page 410, and will not include private notes written by other users. In some embodiments, only partial information about the comments and notes are shown in windows 440, 450 respectively. For instance, the windows 440, 450 may show a title for the comment or note, the author, and the date. If the user wishes to see the comment or note in more detail, the user would click on the appropriate entry in the window 440 or 450. In other embodiments, chapter comments and page notes are not shown in windows 440, 450 on the same screen as the page window 410. Instead, simple links are provided on the reading interface screen 400. Users of the interface 400 would click on a “read chapter comments” link to view all of the available comments on the current chapter, or on the “read page notes” link to view all of the available notes on the current page. These links can include indicators showing the presence of available comments or notes, or even an indicator of the number of comments or notes currently available for review.

When multiple chapter comments 440 are available for the current chapter, it is sometimes useful to search for a particular comment 440. This is true whether the comments are shown in window 440 on the reading interface 400, or are available through a separate screen. Searching is initiated through use of the search button 442. This button 442 allows a user to search for chapter comments 440 that relate to a particular topic, event, or character that appears in the chapter, or to search for comments 440 by a particular user. In one embodiment, the user is only allowed to search for chapter comments 440 related to the chapter associated with the page 410 currently being viewed. In another embodiment, chapter comments from the entire book, or from all books in the user's library, can be searched via the search button 442. In still other embodiments, the main search button 436 allows the user to search for chapter comments 440, thereby eliminating the need for a specific chapter comment search button 442.

To create their own chapter comment, the user presses the new button 444. An editing window then appears (not shown in the figures) that allows the user to input text for the chapter comment. The user is given the option to keep the comment private, share the comment with their group (such as the groups maintained by database entity 350) or friends (as indicated by the user's friend entities 368), or share the comment with all users of the system. When the comment 440 is saved, it is stored in the database as entity 332, and is automatically associated with the user's database entity 300 and the chapter entity 330 for the current book.

Instead of creating a new comment by pressing the new button 444, the user may elect to respond to an existing note through button 446. If this button is pressed, the comment that is created by the user will be associated with the comment that was last read or selected by the user. The comment database entity 332 would then track the relationships between comments 332 in order to create threaded discussions about the current chapter. The user may also give a rating to another user's chapter comment by clicking the rating button 448. Ratings given to a user's chapter comments 332 and notes 346 can be used to help value the contributions to the system by any given user.

The page notes window 450 similarly provides buttons for searching 452, creating new notes 454, responding to an existing page note 456, or rating another user's page note 458. While these buttons 452-458 relate to page notes 346 instead of chapter comments 332, the buttons 452-458 otherwise work in the same way as the chapter comment buttons 442-448.

In the database 210, book entities 310 can be subdivided into sections 320, chapters 330, and pages 340. The reading user interface 400 allows the user to give a rating to the section 320 relating to the current page through the section rating interface 460. This interface 460 could be a simple numerical scale (1-5) or similar rating (1-5 stars), or could be subdivided into categories with separate ratings for each category (for example, a separate rating could be given for the plot, for character development, for adequacy of the translation, etc.). As explained in more detailed in the incorporated application, book level reviews and ratings 314 are generally not permitted until a user has read the entire book. This could also be applied to sections 320, where a user cannot review a section until that user has read the entire section.

Another benefit of the present invention is the ability to find and interact with other users who are reading the same book. The community of other readers window 470 lists other users who are currently reading the same book as shown in window 410. This list can be limited to users actually interacting with the computerized system 100 at that time, or can include users that have used the computerized system 100 within some recent time period (i.e., last 24 hours, the last week, or the last month).

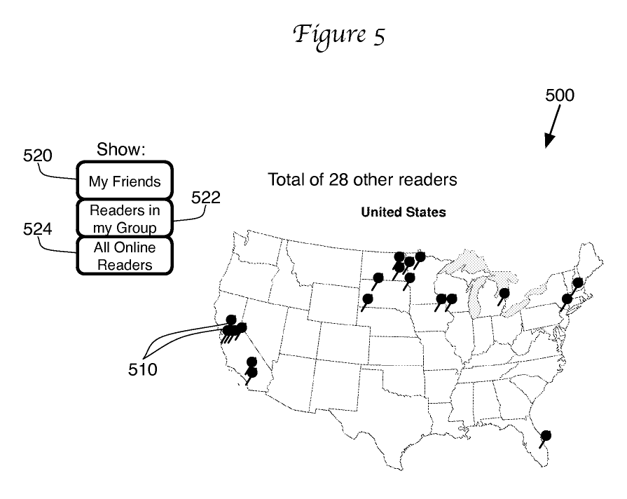

In addition, it can be useful for users looking to make contact with previously unknown readers to be able to locate the other users in the book's community 470. One of the best was to accomplish this is to display a reader map by pressing button 472. The button itself 472 indicates that there are 28 current readers in the community window 470 that will be displayed on the map. When the map button 472 is pressed, the map 500 as shown in FIG. 5 is shown to the user. This map 500 shows a geographical map of a state, a country, a continent, or the entire world with pins 510 indicating the geographic location of the other readers. In the preferred embodiment, a virtual globe is presented as the map 500, such as the Google Earth map provided by Google Inc. of Mountain View, Calif. The map 500 can be filtered to show only the user's friends (using button 520) or readers in the user's group (button 522). The user can return to showing all users through button 524. If the user wants to learn more about another reader, they can simply select a pin 510 on the map 500. The computerized system 100 will respond by presenting information about that user as taken from their user profile. This information may include where the user is in reading the book and when they last read the book. Friend requests can also be made through the profile screen, allowing user to become friends with previously unknown readers of the same book.

Similarly, the user can also filter the community of other readers list 470 shown in the reading interface 400 by friends (button 474) or groups (button not shown). The list 470 can also be filtered according to users who are reading the current chapter (button 476) or current page (button 478). User preferences could be established that allow the page filter button 478 to filter for users with 5 or 10 pages of the current page 410, as opposed to only those readers on exactly the same page. The user may also want to filter the list 470 so as to show only other readers of the book who are in close geographic proximity to the user (button 480). By using multiple filters, the user could cause the list 470 to identify other readers of the same book, who are also on the same chapter or page of the book, who reside close to the current user. By inviting any readers discovered by use of such filters to become the user's friend or join a user's group, the present invention allows users to greatly expand their communal experience around the book that they are currently reading. Note that it would be possible to implement these same chapter or page filters 476, 478 on the reader map 500 shown in FIG. 5, just as it would be possible to include the group filter 522 from the reader map 500 within the filters that apply to the reader list 470.

Like the chapter comment window 440 and the page notes window 450, the community of other readers' window 470 need not appear as shown in FIG. 4. Instead, the user could simply press a button to be shown the list of other readers. Alternatively, the reading interface 400 could simply include the reader map button 472 without the list interface 470. If the user were interested in learning about other readers of the book, the user would press this button 472 and be presented with the reader map 500. The filter by chapter button 476 and filter by page button 478 would then be added to the reader map 500 to include additional methods of filtering the readers shown on the map.

### Document Import Method

FIG. 6 shows a flowchart for a method 600 of importing a document into the database 210 of the computerized system 100. The process 600 begins with an author or publisher using their interface 282, 284, respectively, to initiate the document import process at step 602. The interface 282, 274 then allows the author or publisher to select a file containing the book at step 604, and that file is uploaded into the system in step 606.

At step 608, the file is analyzed by the computerized system 100 for validity. For instance, the system must check that the document contains valid text, and that the file is formatted in an acceptable format. Acceptable formats may include PDF documents, word processing files such as Microsoft Word's Docx XML based format, publishing software formats such as Adobe Framemaker FM or BOOK files, or interchange formats such as RTF or MIF. If the file does not pass the validity check at step 608, the import process is aborted at step 610.

Assuming the file is valid, the method 600 continues at step 612 with the process of extracting the text, pages, and page numbers from the document. At this point, the appropriate entities in the database 210 must be created at step 614. This means that a new book entity 310 is established, and that each page of information from the document should be inserted into the separate page database entities 340 in the database 210. Ideally, the division of chapters and sections can also be determined from the imported file, allowing the creation of these database entities 320, 330 and the associating of the newly created page entities 340 with the appropriate chapter entities 330, section entities 320, and the book entity 310. The text and page numbers for each page that have been extracted from the imported document are then inserted into the page entities 340 at step 616.

At this point, it is necessary to determine at step 618 whether this imported file is duplicative of another book already in the database 210. This can be accomplished in various ways depending on the type of duplication seeking to be avoided. For instance, if the intent is to avoid any book with duplicative text, than a text comparison can be made between the imported document and the books already in the database 210. However, if the goal is to allow duplicative text as long as the page numbering is substantially different (i.e., allowing multiple “editions” of the same text), then the text and page breaks created by the page entities 340 would be compared.

If the book is determined duplicative of an existing book at step 618, the import process is aborted at step 610. If there is no duplicate work in the system, the process continues at step 620. The computerized system 100 is programmed to allow the author or publisher that submitted the book to make edits to the information in the database 210 concerning this book. For instance, the author may wish to make sure that each section and chapter is properly titled, or may wish to avoid sections altogether and simply divide the book into chapters. If a book contains only one section, it can be treated as though it contained no sections whatsoever. In step 620, the author or publisher may edit the individual pages, chapters, and sections to their liking. In step 622, the author or publisher may input and amend book level data, such as the formal title of the book, the publisher, ISBN number, related images and art, etc.

In step 624, the person uploading the book may determine the subscription options for the book. This includes the price for subscribing to the book and its community of interest, the duration of the subscription (i.e., one year or lifetime), and whether or not the book is available to users who pay for an all-you-can-read subscription. These later types of subscription do not require that the user to pay for individual book subscriptions, although access to the books and the related communities will automatically expire at end of their subscription period.

Once the subscription options are established, it is necessary to create graphic page representations for each page entity 340. These graphic images are the images that are presented to the user in the page window 410 of the reading user interface 400. After the graphic page representations are created, the import file process concludes at step 626.

Of course, the system and methods described above are exemplary and are not the exclusive techniques for using the disclosed embodiments. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method of presenting a book to a first user for reading comprising:
a) storing the content of a book as separate pages in a computerized database;
b) presenting the separate pages to the first user through a first user interface created by a web server operating on a server computer;
c) identifying the specific page currently being viewed by the first user by storing information about user interaction with the first user interface in the computerized database;
d) identifying within the computerized database community additions relating to the specific page; and
e) providing the first user the ability to review the community additions determined to relate to the specific page through the first user interface.

2. The method of claim 1, wherein the community additions were created by the first user.

3. The method of claim 1, wherein the community additions were created by a second user, wherein the community additions were created when the second user was viewing the specific page.

4. The method of claim 1, further comprising:
f) identifying a plurality of other users that are also reading the specific page through other user interfaces created by the web server operating on the server computer; and
g) providing, through the first user interface, the ability for the first user to see information about the identified plurality of other users.

5. The method of claim 4, wherein the information about the identified plurality of other users includes the geographic location of the other users.

6. The method of claim 5, further comprising:
h) providing in the first user interface a communication interface for the first user to communicate with at least one of the identified plurality of other users.

7. The method of claim 1, further comprising:
f) identifying, through the web server, a plurality of other users that are reading a page in the book that is within a predefined number of pages of the specific page being viewed by the user; and
g) providing the first user the ability to see information about the identified plurality of other users.

8. The method of claim 7, wherein the information about the identified plurality of other users includes the geographic location of the other users.

9. The method of claim 8, further comprising:
h) providing a communication interface for the first user to communicate with at least one of the identified plurality of other users.

10. A system for presenting a book to a user for reading comprising:
a) a processor for processing software instructions;
b) a database containing separate entities for
i) users,
ii) books,
iii) pages within the books, and
iv) community additions relating to the pages within the books;
c) a tangible, non-transitory memory containing software instructions, the software instructions causing the processor to
i) present a user interface to a user, the user interface presenting the user the contents of a book on a page-by-page basis using the page entities in the database,
ii) identify a specific page currently being viewed by the user through the user interface;
iii) identify a plurality of community additions relating to the specific page; and
iv) provides to the user through the user interface the ability to review the community additions determined to relate to the specific page.

11. The system of claim 10, wherein the software instructions further cause the processor to:
v) receive input from the user in the form of a community addition,
vi) store the community addition as a separate entity in the database, and
vi) maintain a relationship between the community addition entity and the page entity associated with the specific page.
